(19) United States
(12) Patent Application Publication
(10) Pub. No.: US 2022/0331730 A1
(43) Pub. Date: Oct. 20, 2022

(54) AIR PURIFYING FILTER, APPARATUS INCLUDING THE SAME, AND METHODS OF MAKING AND USING THE SAME

(71) Applicant: XIHUA UNIVERSITY, Chengdu (CN)

(72) Inventors: Qinyong ZHANG, Chengdu (CN); Jialin REN, Chengdu (CN); Xiaobo LEI, Chengdu (CN); Guocai YUAN, Chengdu (CN)

(21) Appl. No.: 17/810,449

(22) Filed: Jul. 1, 2022

Related U.S. Application Data
(63) Continuation of application No. PCT/CN2020/137601, filed on Dec. 18, 2020.

(30) Foreign Application Priority Data
Oct. 30, 2020 (CN) 202011192221.5
Oct. 30, 2020 (CN) 202022468037.0

(51) Int. Cl. B01D 46/42; B01D 39/20; B01D 46/00; B01D 46/52; B01D 46/10

(52) U.S. Cl. CPC B01D 46/4263; B01D 39/2017; B01D 46/4245; B01D 46/0005; B01D 46/523; B01D 46/10; B01D 2265/04; B01D 2277/30; B01D 2271/027; B01D 2275/20

(57) ABSTRACT

An air filter and air purification technology including a frame encompassing a filter channel and a filter medium across the filter channel. The air filter and air purification technology also include one or more electrical heating components, placed in the filter channel and configured to heat the filter medium and/or air in the filter channel. Thus, the air filter has a heating function, and can heat the filter medium and the air in the filter channel according to actual working conditions and/or operations, so as to prevent moisture in the air from affecting the filtering efficiency of the filter medium. The air filter and air purification technology have the characteristics of enhancing the filtering effects and improving the service life of the filter.

### CROSS REFERENCE TO RELATED APPLICATIONS

The present application is a continuation of International Appl. No. PCT/CN2020/137601, filed Dec. 18, 2020, pending, which claims priority to Chinese Pat. Appl. Nos. 202011192221.5 and 202022468037.0, each of which was filed Oct. 30, 2020, all of which are incorporated herein by reference in their entireties.

### FIELD OF THE INVENTION

The present invention relates to the technical field of air purification, and in particular, to heating elements and baffles for use in air purification.

### DISCUSSION OF THE BACKGROUND

At present, increasingly serious air pollution greatly promotes demand by the public for air purifiers. Due to increases in residential and industrial concentrations, the air quality deteriorates further. In order to improve the existing living and construction environment, air purifiers are used to improve the air quality.

Among existing technologies, there are many kinds of air purifiers. High-efficiency baffle filters are common high-precision air purifiers, mainly used to remove particles below 0.3 μm suspended in air. Such baffle filters can usually be used as the final filtration device in various filtration systems. For example, it is widely used in air filtration in electronics factories, semiconductor fabs, precision machinery shops, and the pharmaceutical, hospital, food and other industries to meet requirements for high air cleanliness in civil or industrial plants.

The existing baffle filter usually includes an outer frame for enclosing the filter channel, a fiberglass filter sheet, which is set inside the outer frame as the filter medium, and a rubber sheet or aluminum foil sheet, which is folded as the partition to achieve separation of and support for the filter medium. During operation, indoor air is pulled into the outer frame by fans or other devices. The air is filtered through the fiberglass filter sheet and then sent back into the room, to achieve the purpose of air purification. However, because the humidity of the air is different in different environments, in actual use, existing high efficiency baffle filters have a range of filtration efficiencies, especially at higher humidity (e.g., wet air), which leads greatly reduced filter filtration efficiency. Consequently, the filtering effect becomes poor, the service life short, and other issues arise. However, existing technology does not have an effective technical means to solve the above problems, and it is urgent to solve.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The purpose of the invention is to improve the deficiencies existing in the prior art and provide a compact, reasonable design and heating function for the air filter, which can effectively solve the deficiencies in the prior art.

The technical scheme of the invention is as follows. A first aspect of the present invention is to solve the problem caused by humid air to influence (e.g., decrease) the efficiency of the filter, and to provide an air filter, comprising: an outer frame enclosing a filtering channel; a transverse filter medium in the filtering channel; and one or more electrical heating components in the filtering channel, configured to generate heat to heat the filter medium and/or the air in the filter channel when energized. In this approach, the electric heating component(s) are configured in the filter channel so that the electric heating component(s) generate heat when an electric potential or current is applied, to heat the filter medium and/or the air in the filter channel so that the filter medium remains dry and the filtration efficiency is maintained or improved, so as to effectively solve the problem associated with wet filter media caused by incoming wet air, which may decrease the filtration efficiency. At the same time, the heat generated by the electric heating component(s) can also be used to provide heated air, in addition to reducing the humidity of the air and preventing the humid air from wetting or moistening the filter medium, and thus raise the temperature of the environmental air or output air having a set temperature. At the same time, it is beneficial to control the temperature uniformity of the air output from the present air filter (or system including the present air filter).

In order to effectively intercept particles below 0.3 μm suspended in the air, an optimal material for the filter medium is glass fiber filter paper. In particular, high temperature-resistant glass fiber filter paper can be used to effectively intercept the particles below 0.3 μm suspended in the air, which is conducive to enhancing the filtering effect.

A second aspect of the invention is to solve the problem of increasing the area of the filter medium through which the air passes, thereby improving the filtering efficiency. In one aspect, the filter medium is positioned along a transverse direction of the filter channel, and contains at least one bend. The electric heating component(s) are between sections of the filter medium on opposite sides of the bend(s), and the electric heating component(s) may support the filter medium and separate the filter medium on opposite sides of the bend. Alternatively, one or more of the electric heating component(s) may pass between sections of the filter medium on opposite sides of a selected bend, and may be perpendicularly offset from the filter medium. In this scenario, the electric heating component (e.g., an electric heating element) not only heats the filter medium and/or air in the filter channel, it can also support and/or constrain the filter medium. The filter medium can have at least one bend oriented along the transverse direction of the filtering channel, and can ensure that the bend remains essentially unchanged in the process of use. The filter medium has an area through which air passes (an “air passing area”) that is at least the sum of the areas of the filter material in each bend, plus some or all of the filter material on opposite sides of the bens (or, when the filter medium contains a plurality of bends, the filter material between each pair of adjacent bends). It is typically much larger than the cross-sectional area of the filter channel, which increases the area of air flow through the filter medium, and thus effectively improves the filtration efficiency.

To further increase the area of air flow through the filter medium, preferably, the filter medium has a wavy or corrugated structure, or comprises a series of right-angle bends. Alternatively, the filter medium is constrained to a wavy structure, a corrugated structure or a series of alternating right-angle bends or pairs of right-angle bends. The electric heating component(s) may comprise a sheet, which may further include one or more corrugated sections and/or a series of alternating right-angle bends. In this scenario, the filter medium may also have a wavy or corrugated structure, or a series of alternating pairs of right-angle bends, so that the bends and/or the shape of the electric heating component(s) are adapted to the shape and/or spacing of the bend(s). This advantageously increases the air passing area, and the filter medium and the shape of the electric heating component(s) can have multiple bends adapted to each other, and the number of electrical heating component(s) can be set according to actual demand. When the shape of the electric heating component(s) matches the spacing between bends in the filter medium and between sections of the filter medium between the bends, it is easy to insert a baffle (e.g., an electric heating component having the form and/or function of a baffle) into the corresponding bends in the filter medium and/or between the sections of the filter medium between the bends, to support the filter medium and space the sections of the filter medium apart. Multiple bends in the filter medium can be convenient to put baffles into the spaces between the sections, also to support the filter medium and space the sections apart.

Preferably, the electric heating component(s) comprise a metal or alloy conductive material.

In order to facilitate the conversion of electrical energy into heat, the electric heating component(s) preferably comprise stainless steel, nickel, iron, chromium, aluminum or an alloy thereof (e.g., a nickel-chromium or iron-chromium-aluminum alloy). Properties and/or parameters of the electric heating component(s) (e.g., wire diameter, wire mesh aperture and other parameters) can be adjusted according to needs.

A third aspect of the invention is to solve the problems of control resistance and temperature uniformity. In some embodiments, the electric heating component(s) may comprise a mesh or have a surface with a plurality of mesh holes, forming a kind of net from or network in the electric heating component(s). Alternatively, the electric heating component(s) may comprise a metal mesh (e.g., a plurality of metal wires oriented along two different directions, in which the wires in each direction alternately cross over and under the wires in the other direction). In this approach, the electric heating component(s) comprising a plurality of mesh holes can not only better control the resistance and temperature uniformity of the electric heating component(s), but also achieve a better ventilation effect (e.g., air can pass through a mesh more easily than it can through a sheet without holes). In addition, when the electric heating component(s) comprise a mesh, the mechanical strength is reduced relative to a sheet without holes, beneficially making the mechanical strength of the electric heating component(s) more appropriate for bending by machine (e.g., to process the electric heating component[s] into the wavy or corrugated structure, or to form the series of alternating right-angle bends in the electric heating component[s]).

A fourth aspect of the invention is to solve the problem of controlling the spacing of the sections of the filter material between the bends. Further, the electric heating component(s) may have a wavy or corrugated structure, or comprise a series of alternating right-angle bends along its length. In this approach, the thickness of the electric heating component(s) can be effectively changed by forming waves, corrugation, or alternating right-angle bends in the electric heating component(s) along its length, so as to effectively change the spacing between the sections of the filter medium of opposite sides of each bend, and thus effectively control the spacing of the filter medium sections between the bends. In addition, it can also effectively reduce the contact area between the electric heating component(s) and the filter medium, so as to effectively reduce the shielding of the electric heating component(s) and the filter medium, which is conducive to increasing the air passing area of the filter medium.

A fifth aspect of the invention is to solve the problem of adjusting the heating rate and controlling temperature uniformity of the electric heating component(s) and/or in the filter medium. For example, opposite ends of each electric heating component are respectively connected to a power supply, or ends of two adjacent electric heating components are respectively connected to the power supply.

Alternatively, at least two connections or connectors to power supplies are included, the two adjacent electric heating components are connected in series with a conductive sheet or wire, and the connector is respectively connected with an electric heating component, and there is at least one further electric heating component between the two connections or connectors. In this case, by including multiple connections or connectors, it is not only convenient for wiring, such as to connect the power supply and achieve the purpose of supplying power, but also has at least the following effects: 1. It can solve the problems of heating rate adjustment and temperature uniformity control, as the user can select different numbers of power supply connectors and/or different positions for the power supply connectors, and the connectors may be arranged serially and/or in parallel to effectively adjust or control the heating rate. For the purpose of effectively controlling temperature uniformity. 2. When a plurality of connectors are present, if one electric heating component or connector breaks down or is damaged, the electric heating component or connector need not be replaced (in some commercially advantageous embodiments, the air filter cannot be disassembled, and the internal components cannot be replaced), and the faulty or damaged electric heating component or connector can continue to support and/or constrain the filter material, so that the need not be repaired or replaced, and the service life of the air filter can be effectively prolonged. 3. Multiple connectors can significantly increase the versatility of air filter, because there can be multiple settings for electrical connectivity of the heating components, and the user can select and/or adjust the settings, such as the number of active connections, their positions, the series or parallel state of the electrical heating component(s) and/or the power supply, etc., according to regional and/or seasonal differences in temperature, to meet various needs during different occasions, to provide strong versatility, and to be more in line with market demands.

Preferably, the connector is detachable and mounted on the electric heating component(s) or the conductive sheet.

A sixth aspect of the invention is to solve the problem of fixing the filter medium and the electric heating component(s) (e.g., together or to each other). Further, ends (e.g., the upper and lower ends) of the filter medium and the electric heating component(s) may be fixed to the filter channel (e.g., the top and bottom, respectively, of the outer frame defining the filter channel) with a sealant and/or adhesive.

At least part of the connector may be in the sealant and/or adhesive. By fixing the filter medium and the upper and lower end of the electrical heating components with the sealant and/or adhesive, it can not only effectively fix the filter medium and electric heating components, but can also form an insulation between the filter medium and the electric heating components, so that part or all of the connector(s) may conveniently be insulated, which solves both the problem of how to insulate and effectively protect the connector(s) and the wire(s) at the connector, as well solve the problem of the connector(s) and the wire(s) at the connector(s) aging due to environmental factors. In addition, the sealant and/or adhesive may beneficially make the air filter and/or the structure thereof to be more compact.

In order to solve the cost problem, a plurality of baffles may be further included in the filter channel. The baffles may be adjacent to one or more selected bends, and are used to support and separate the filter material on opposite sides of the selected bend(s).

Each baffle may comprise an aluminum, plastic and/or ceramic partition, plate or board. In this scenario, the baffles can be adjacent to the bend, and the electrical heating component(s) need not support the filter medium or maintain space between adjacent sections of the filter medium on opposite sides of the bend. The baffles are not necessary for heating, so the electrical conductivity of the baffles is not a consideration. The baffles may comprise a less expensive material than the electrical heating component(s), so they may lower the cost of the filter, yet provide any necessary degree of stiffness and strength.

Preferably, the structure of each baffle is the same as or similar to that of the electric heating component(s). The baffles can realize all functions of the electric heating component(s) except heating, and solve the corresponding technical problems.

Compared with prior art, the present air filter has the following beneficial effects:
1. During operation, the filter with heating function can heat the filter medium and air passing therethrough according to actual working conditions, prevent moisture in the air from affecting the filter medium filtration efficiency, enhance the filtering effect, improve the service life of the filter, etc.
2. The number and position(s) or location(s) of active electric heating component(s), as well as the series and/or parallel mode, can be set in the present filter according to the actual demand. The present filter can realize the adjustment of the heating rate and can control temperature uniformity.
3. The filter is also suitable for winter, and can heat the purified air to improve the user's comfort.

These and other advantages of the present invention will become readily apparent from the detailed description of various embodiments below.

### BRIEF DESCRIPTION OF THE DRAWINGS

In order to more clearly explain the invention, the following examples will be described with reference to the drawings as needed. It should be understood that the drawings show only some embodiments of the present invention, and should not be regarded as limiting the invention, as persons of technical skill in the art may derive other, related embodiments from the drawings without inventive effort.

FIG. 1 is a structural diagram of an outer frame of an air filter provided in Embodiment 1 of the present invention.

FIG. 2 is a schematic diagram of a filter medium (containing a series of alternating pairs of right-angle bends) in an air filter provided in Embodiment 1 of the present invention.

FIG. 3 is a top view of the filter medium in FIG. 2.

FIG. 4 is a top view of an alternative filter medium (the filter medium has a wave-shaped structure) in an air filter provided in Embodiment 1 of the present invention.

FIG. 5 is a top view of another filter medium (the filter medium has a corrugated structure) in an air filter provided in Embodiment 1 of the present invention.

FIG. 6 is a structural diagram of an electric heating component in an air filter provided in Embodiment 1 of the present invention (the electric heating component has a corrugated structure along its length).

FIG. 7 is a front or edge-on view of the electric heating component in FIG. 6.

FIG. 8 is a structural diagram of another electric heating component in an air filter provided in Embodiment 1 of the present invention (the electric heating component has a wavy structure along its length).

FIG. 9 shows a partial cross-sectional view of an air filter provided in Embodiment 1 of the present invention.

FIG. 10 is a front view of the air filter in FIG. 9.

FIG. 11 is a cross-sectional view of the air filter of FIG. 10 along the line A-A.

FIG. 12 is a cross-sectional view of the air filter of FIG. 10.

FIG. 13 is a diagram of an electric heating component in an air filter provided in Embodiment 2 of the present invention (the electric heating component has a continuous alternating right-angle bending structure).

FIG. 14 is a diagram showing the interlaced electric heating component of FIG. 13 and filter medium of FIG. 2.

FIG. 15 is a top view of the interlaced electric heating component and filter medium of FIG. 14.

FIG. 16 is a cross-sectional view of the interlaced electric heating component and filter medium of FIG. 15 along the line the B-B.

FIG. 17 is a structural diagram of an electric heating component in an air filter provided in Embodiment 2 of the present invention (the electric heating component has a truncated V-shaped bend and sections on opposite side of the bend comprising a series of alternating right-angle bends, in an overall “bent U-shaped” structure).

FIG. 18 is a structural diagram of an electric heating component in an air filter provided in Embodiment 2 of the present invention (similar to that in FIG. 17 but having a “bent S-shaped” structure).

FIG. 19 is a structural diagram of an air filter provided in Embodiment 3 of the present invention.

Description of the structures in the figures: Outer frame 101, filter channel 102, filter medium 201, bend 202, windward side 203, leeward side 204, electric heating component 301, sealant 401, connector 501, conductive sheet 502, baffles 601.

### DETAILED DESCRIPTION

The following is a clear and complete description of the technical scheme in the embodiments of the present invention in combination with the drawings attached to the embodiments of the present invention. Obviously, the described embodiments are only part of the embodiments of the present invention, but not all embodiments. The components of embodiments of the invention usually described and shown in drawings attached herein may be arranged and designed in various configurations. Therefore, the detailed descriptions of embodiments of the invention provided in the appended drawings below are not intended to limit the scope of the invention for which protection is required, but rather represent only selected embodiments of the invention. Based on embodiments of the invention, all other embodiments obtained by the technical personnel in the field without making creative labor are covered by the invention. Furthermore, it should be understood that the possible permutations and combinations described herein are not meant to limit the invention. Specifically, variations that are not inconsistent may be mixed and matched as desired.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

The invention, in its various aspects, will be explained in greater detail below with regard to exemplary embodiments.

### Example 1

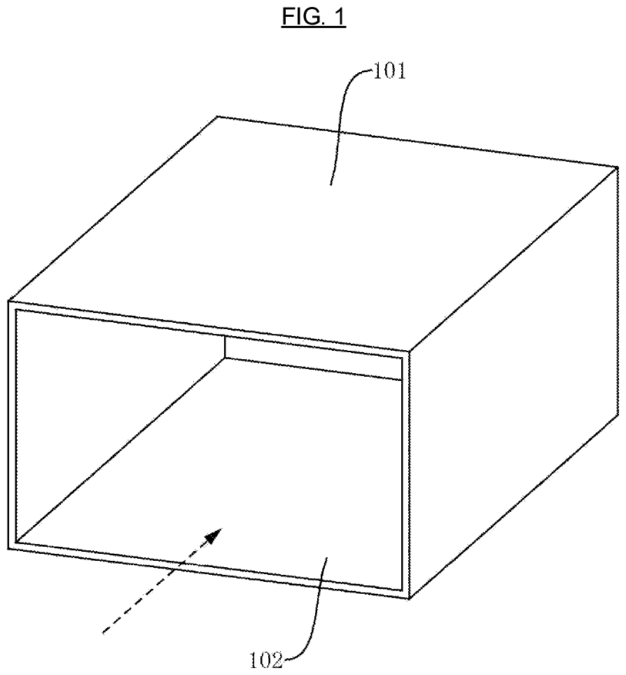

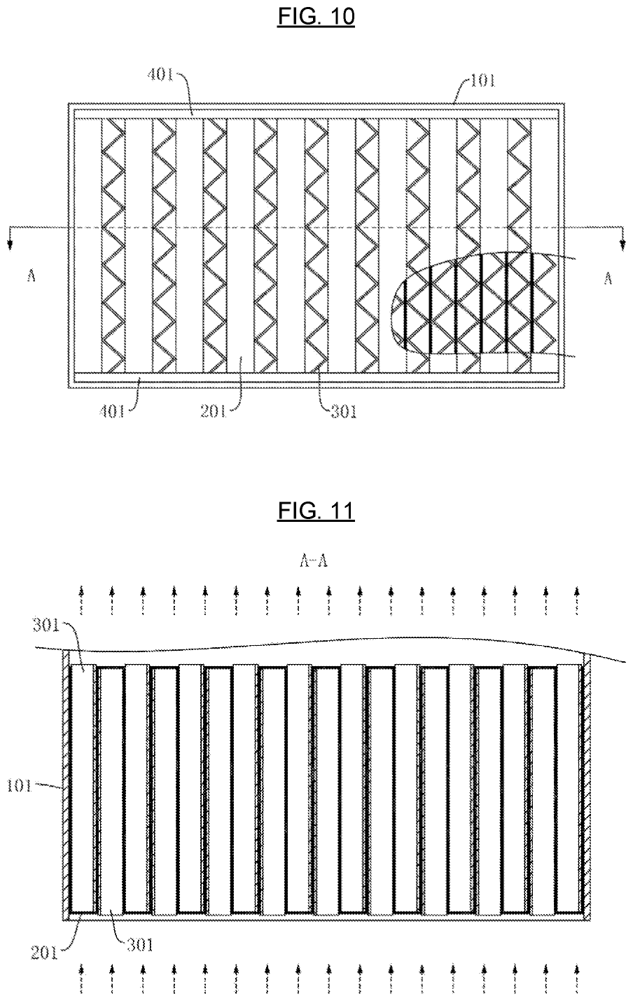

See FIGS. 1-12. An air filter is provided in this embodiment including an outer frame 101 for enclosing the filter channel 102.

In this embodiment, the outer frame 101 can comprise or be made of stainless steel preferentially. However, other materials, such as aluminum, are also acceptable. The shape of the outer frame 101 can be determined according to actual needs. Examples are shown in FIGS. 1 and 9. The outer frame 101 can also have a square or cylindrical cross-sectional shape (e.g., across the channel 102), etc., in addition to the rectangular cross-sectional shapes shown in the Figures. The size of the outer frame 101 can also be determined according to actual requirements. As an example, in this embodiment, the outer frame 101 may have dimensions of 300-1000 mm in width, 300-1000 mm in depth, and 150-600 mm in height. In one example, the dimensions are 610*610*292 mm³. In general, the larger the size of the outer frame 101, the larger the cross-sectional area of the filter channel 102, and the greater the amount of air that can be processed per unit time.

In order to intercept the particles suspended in the air and achieve the purpose of purifying the air, in this embodiment, the filter medium 201 is also across the entire filter channel 102, as shown in FIG. 9. The filter medium 201 is the filter channel 102, substantially from side wall to side wall and substantially from top to bottom of the frame 101. The air entering the filter channel 102 flows to the filter medium 201, continues along the filter channel 102 after passing through the filter medium 201, and then exits the filter channel 102.

As shown in FIG. 9, in this embodiment, the filter also includes an electric heating component 301, which is in the filter channel 102 to heat the filter medium 201 and/or the air in the filter channel 102 when energized. Specifically, by placing the electric heating component 301 in the filter channel 102, the electric heating component 301 generates heat (e.g., when electrical current is passed through it), so that the heat can heat the filter medium 201 in the filter channel 102, thereby keeping the filter medium 201 dry and maintaining the filtering efficiency. At the same time, the heat generated by the electric heating component 301 can also synchronously heat the air in the filter channel 102, which can not only reduce the humidity of the air and prevent the air from wetting the filter medium 201, but also increase the temperature of the air, so as to facilitate outputting the air at a set temperature and controlling the temperature uniformity of the output air.

In order to intercept particles having a size of 0.3 μm or less suspended in the air, the filter medium 201 preferentially comprises glass fiber filter paper, especially high temperature-resistant glass fiber filter paper, which can effectively intercept suspended particles of 0.3 μm size or less in the air, so as to enhance the filtering effect. As an example, in this embodiment, the filter medium 201 may comprise H13 high-effect glass fiber filter paper.

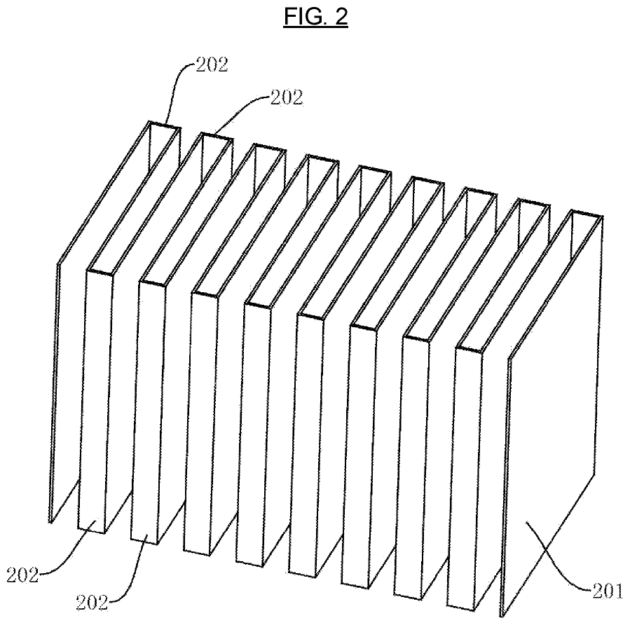

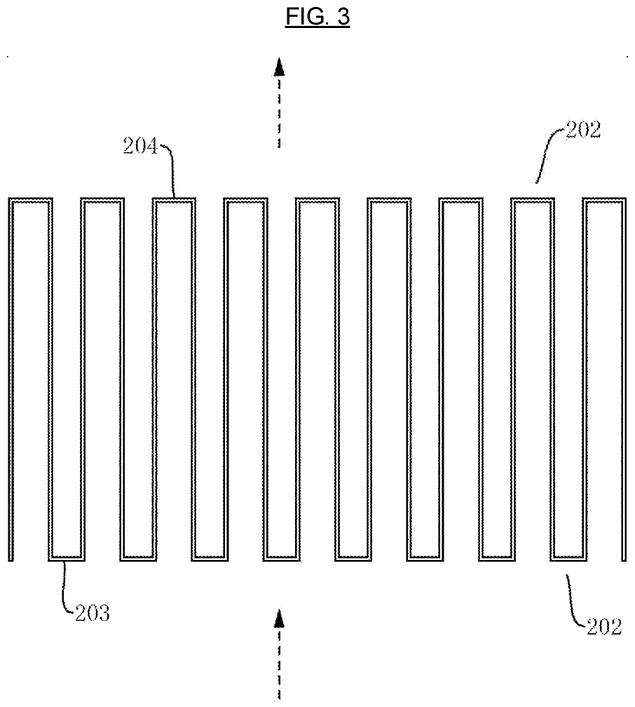

In order to increase the air passing area or air flow area of the filter medium 201 and improve the filtering efficiency, in this embodiment, the filter medium 201 includes at least one bend 202 along a direction crossing the filter channel 102 (e.g., the transverse direction), as shown in FIGS. 2-5. The transverse direction may be along the width or the height of the outer frame 101. By constructing the bends 202, the air passing area of the filter medium 201 can be equal to the sum of the area of the filter medium 201 at each bend 202 plus at least part of the area of the filter medium 201 between the bends 202, which is far greater than the area of the windward surface 203 of the filter medium 201 (FIG. 3), so as to increase the air passing area of the filter medium 201 and improve the filtration efficiency.

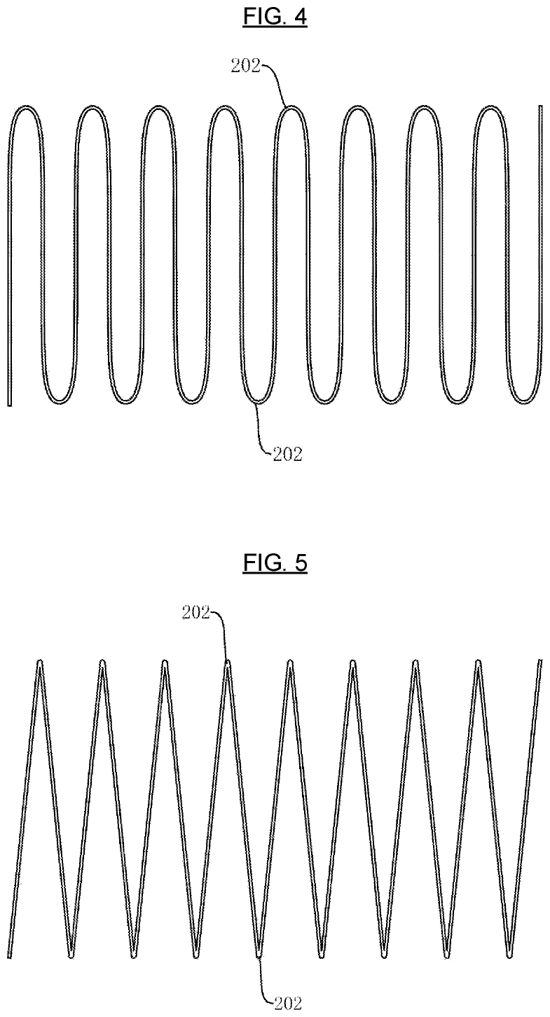

In this embodiment, the number, shape, and size of the bends 202 can be determined according to actual requirements, and the filter medium 201 can be directly processed into a wavy structure (e.g., FIGS. 4 and 8), a corrugated structure (e.g., FIGS. 5-7), or a structure containing a series of alternating pairs of right-angle bends (e.g., FIGS. 2-3). Alternatively or additionally, and optionally during the installation process, the filter medium 201 may be constrained by one or more other components (such as the electric heating component[s] 301, etc.) to impart the wavy structure, corrugated structure, or alternating pairs of right-angle bends.

As in the first example, the filter medium 201 can comprise alternating pairs of right-angle bends 202, as shown in FIGS. 2 and 3. The bends 202 may be on the windward side 203 or the leeward side 204 of the filter 201. In actual use, air can pass from one side 203/204 of the filter medium 201 to the other side 204/203 of the filter medium 201. In this process, part of the air can directly enter the bend 202 and pass through the filter medium 201 through the windward side 203, as shown in FIG. 3. Another part of the air can pass under pressure through the leeward side 204 and the sections of the filter medium 201 between adjacent bends in different directions. Thus, the ventilation area of the filter medium 201 can be greatly increased.

In a second example, the filter medium 201 can have a wavy structure, as shown in FIG. 4. A series of multiple and/or continuous bends 202 can also increase the ventilation or air passing area of the filter medium 201.

In a third example, the filter medium 201 can have corrugated structure. The corrugated structure may include a V-, U- or UV-shape commonly used in existing technology. For example, as shown in FIG. 5, the filter medium 201 may have a V-shaped corrugated structure, which can also form multiple alternating bends 202. To increase the air passing area of the filter medium 201, and the U- and UV-shape can also achieve the same purpose.

In this embodiment, the electric heating component 301 can release heat when energized. Therefore, the electric heating component 301 mainly converts electric energy into heat energy. Based on the consideration of the material of the electric heating component 301, there are various implementation modes. The electrical heating component 301 may be chosen preferentially from a metal or conductive metal alloy, to make electrical heating component(s) 301 with a predetermined resistance, to effectively control the heating rate and/or heat generated by the electrical heating component(s) 301. Preferably, the electric heating component(s) 301 comprise chromium, nickel, iron, aluminum or an alloy thereof (e.g., stainless steel, or a nickel-chromium alloy). When the electric heating component 301 comprises stainless steel, nickel, ferrochrome-aluminum alloy or nickel-chromium alloy, the electric heating component 301 has very good anti-aging properties. During use, especially in the energized state, such electric heating components 301 may not easily react with oxygen. As a result, the electric heating component 301 may have very good stability, which is conducive to prolonging the service life.

In this embodiment, the electric heating component 301 is not only configured to heat the filter medium 201 and/or air in the filter channel 102, but also to support and/or restrain the filter medium 201 to ensure that the shape of the bend(s) 202 in the filter medium 201 remain substantially unchanged, especially under air pressure, to substantially avoid deformations and stabilize the filter medium 201.

Based on the shape and/or design of the electric heating component 301, in order to better support and/or restrain the filter medium 201, in one example, the electric heating component 301 can be preferentially placed inside the bends 202, as shown in FIGS. 9-12. In such an arrangement, the electric heating component(s) 301 can not only support the filter medium 201, but also play a role in separating sections of the filter medium 201 on both sides of the bend(s) 202, as shown in FIGS. 9-12.

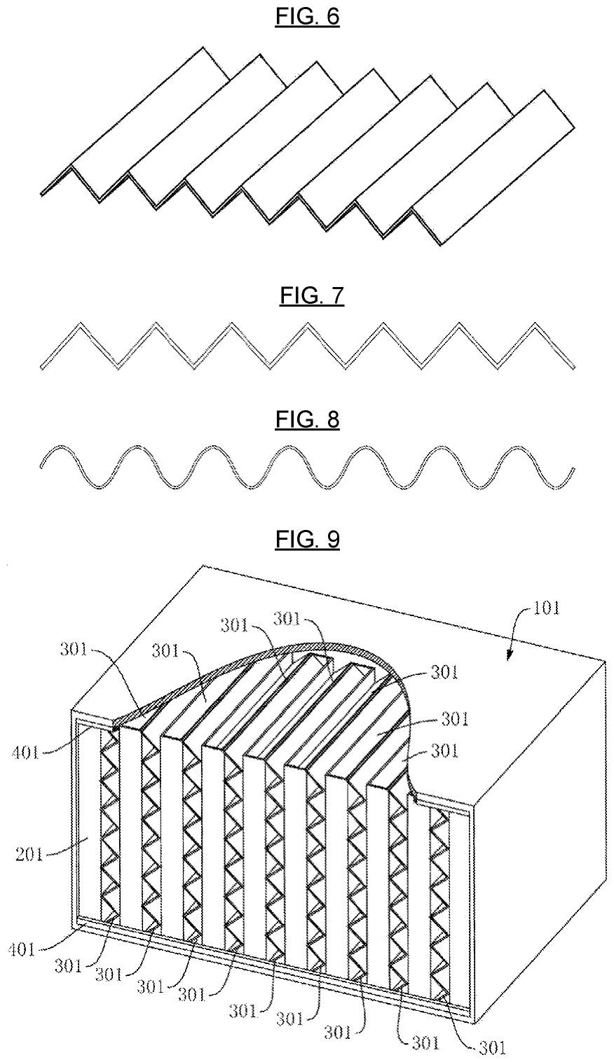

In this embodiment, the number and position of the electric heating component(s) 301 can be determined according to demand. In one embodiment, the electric heating component 301 can be set in each bend 202 and/or between sections of the filter medium 201 on opposite sides of each bend, as shown in FIGS. 9-12. In another embodiment, the electric heating component 301 can also be arranged in a selected bend 202. For example, the electric heating component 301 can be arranged in a bend 202 on the leeward side 204 of the filter medium 201. In order to place the electric heating component 301 in the selected bend 202, the electric heating component 301 can have a sheet structure, as shown in FIGS. 6, 7 and 9-12, so as to achieve an effect of fragmentation distribution. In order to effectively control the spacing of the filter medium 201 on both sides of the bend 202, the electric heating component 301 can be configured along its length into a wavy structure (as shown in FIG. 8), a corrugated structure (as shown in FIGS. 6 and 7, a V-shaped corrugated structure) or a series of alternating pairs of right-angle bends (as shown in FIGS. 2-3), so as to change the effective thickness of the electric heating component 301 and effectively control the spacing between sections of the filter medium 201 on both sides of the bend 202. In addition, such structures can also effectively reduce the contact area between the electric heating component 301 and the filter medium 201, so as to effectively reduce the shielding of the electric heating component 301 and the filter medium 201, which is conducive to increasing the air passing area of the filter medium 201.

In a further embodiment, the surface of the electric heating component 301 can include a plurality of holes. For example, the electric heating component 301 may comprise a mesh. As an example, the electric heating component 301 can be a metal plate or sheet, and the holes can be formed (e.g., by conventional processing) on the surface of the metal plate or sheet, and such processing can be continuous. Such processing can also form the wavy structure, corrugated structure or series of alternating pairs of right-angle bends along the length of the metal plate or sheet. In another example, the electric heating component 301 can also comprise a mesh of interwoven metal wires. The diameter of the wire, the aperture of the metal mesh (e.g., hole size or diameter) and other parameters can be adjusted according to needs. For example, the mesh of interwoven metal wires for the electric heating component 301 may comprise 200 mesh stainless steel (not shown). The above two embodiments can include electric heating component(s) 301 comprising a plurality of holes on the surface or through the electric heating component(s) 301. By configuring the holes, the electric heating component 301 can comprise a mesh, which improves ventilation or air flow relative to an otherwise identical metal plate or sheet without holes, and provides better heat dissipation, while still blocking transverse air flow, and improving control of the electrical and/or thermal resistance and temperature uniformity.

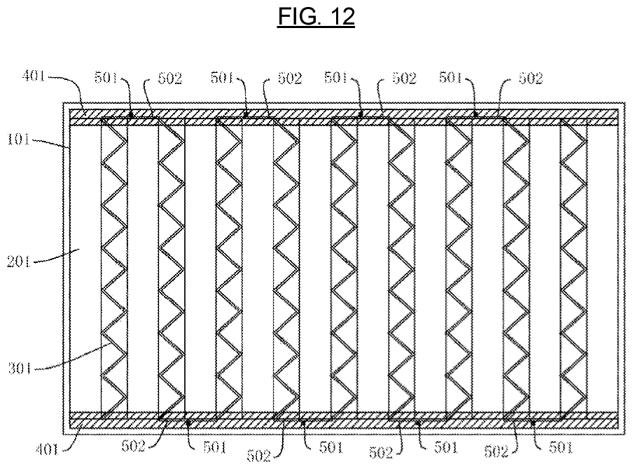

In this embodiment, after the filter medium 201 and the electric heating component 301 are respectively in the filter channel 102 within the outer frame 101, the position of at least the electric heating component 301 needs to be secured. As an example, in one embodiment, opposite (e.g., upper and lower) ends of the filter medium 201 and the electric heating component 301 can be fixed to opposite surfaces (e.g., top and bottom surfaces) of the outer frame 101 with a sealant or adhesive 401, as shown in FIGS. 9 and 12. The sealant or adhesive 401 can comprise a conventional high temperature-resistant sealant 401.

In a further embodiment, in order to facilitate the connection of one or more power sources (e.g., according to actual needs) and realize different series and parallel connections (e.g., among a plurality of electric heating components 301 or sections of a single heating component 301), one or more of the electric heating component(s) 301 may connected to each of a plurality of power supply connectors 501 at a plurality of locations. Alternatively, ends of two adjacent electric heating components 301 may be connected to the same power supply connector 501, as may be shown in FIG. 12. For example, the connector 501 can be fixed or secured to a conductive sheet 502, and opposite ends of the conductive sheet 502 can be fixed or joined to the two adjacent electric heating components 301. The connector 501 can preferentially comprise or be made of a conductive metal material. For example, the connector 501 can comprise or made of copper or stainless steel, so as to conduct electricity. In addition, the sealant or adhesive 401 may have a set or predetermined thickness, and may form an insulation area at opposite sides (e.g., the top and bottom) of the filter channel 102. It may be convenient to put the connector 501 partially (such as the lower end of the connector 501) or completely in the insulation area formed by the sealant or adhesive 401, which can not only protect the connector 501, but also make the overall structure more compact. With such a design, in actual use, a selected connector 501 (including the selected location and the selected number of connectors 501, and in which any electric heating component[s] 301 connected to an unselected connector 501 providing mechanical support without heating) can be connected to the power supply by a switch coupled to a power supply wire, according to demand. Such connection arrangements can enable a user to effectively control series and parallel modes of the connectors 501 and the power supply, so that in actual use, according to the heating rate of the heating components and the demand to adjust the position and mode of connection to the external power supply, a slow or rapid heating function can be realized, facilitating adjustment of the heating rate and temperature uniformity control.

In another embodiment, two adjacent electric heating components 301 may be connected to a conductive sheet or strip 502 (or a wire series, not shown), in which case the filter may include at least two power supply connectors 501. The connector(s) 501 are respectively connected to the electric heating component 301, but the position and number of the connectors 501 can be determined according to design parameters and/or the actual demand. However, there should be at least one electric heating component 301 between any two connectors 501. For example, the present air filter can include five electric heating components 301. The five electric heating components 301 can be connected in series using conductive sheets 502 (e.g., four conductive sheets 502). For example, a first connector 501 and a second connector 501 can be placed at or near respective ends of a first electric heating component 301 and a last electric heating component 301, so that when the first and second connectors 501 provide the power supply from respective power supply wires, the five electric heating components 301 can be connected in series with the power supply. For example, in addition, a third connector 501 can be placed in the middle of the five electric heating components 301, so that at least two of the first connector 501, the second connector 501 and the third connector 501 can be connected to the power supply (e.g., according to actual needs). The parameters such as heating position and heating voltage can be effectively changed so that the heating rate can be effectively adjusted and the temperature uniformity can be effectively controlled.

Preferably, the connector 501 is conventional, and the connector 501 may be detachable and mounted on the electric heating component 301 or conductive sheet 502. For example, the connector 501 may be bolted or screwed to the electric heating component 301 or conductive sheet 502, or soldered to the electric heating component 301 or conductive sheet 502. The conductive sheet 502 can also be fixed to the electric heating component 301 with bolts or screws, conductive solder or welding, etc.

A more complete embodiment also includes a power supply, which is connected to the connector(s) 501 by a wire (e.g., to supply power).

In order to avoid the influence of the electric heating component 301 on air passing through the filter channel 102, in this embodiment, its length of the filter channel 102 is parallel to the surface of the electric heating component 301, as shown in FIG. 9. In other words, the plane(s) of the electric heating component(s) 301 may be parallel to the side walls of the outer frame 101.

### Example 2

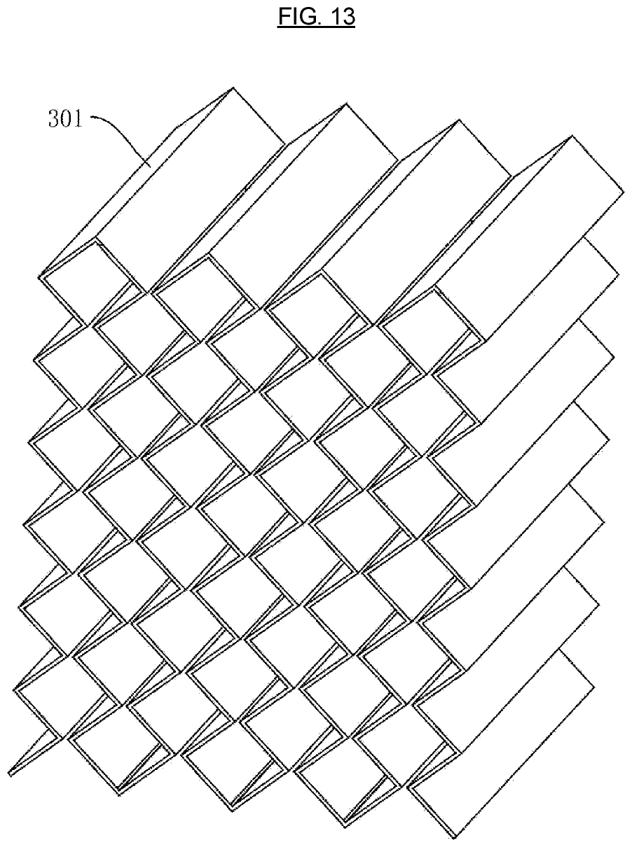

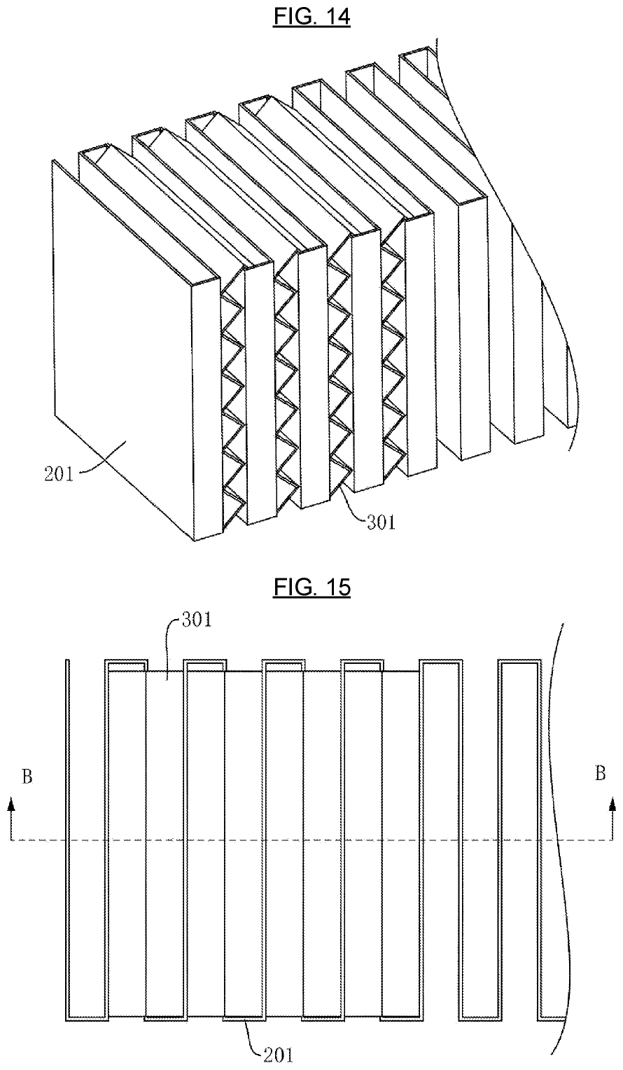

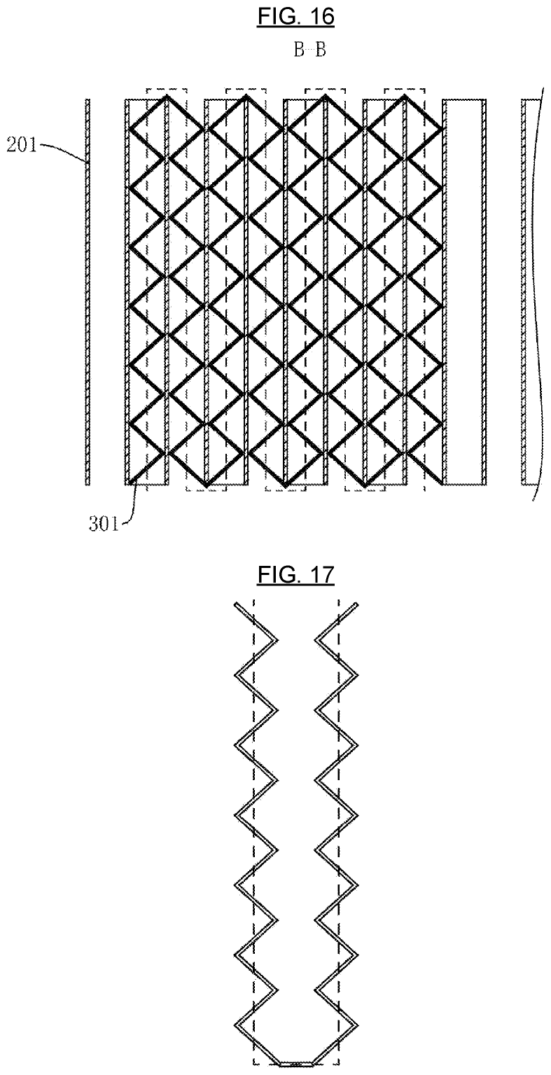

Also based on the shape and/or design of the electric heating component 301, in order to better support and restrain the filter medium 201, the electric heating component 301 in the filter provided in this embodiment can have another structure. Specifically, as shown in FIGS. 13-16, the electric heating component 301 is interleaved with the filter medium 201 in directions perpendicular to each other. That is, in this embodiment, the electric heating component 301 comprises a plurality of sections, each section comprising a series of alternating right-angle bends, and a plurality of turning ends connecting adjacent sections to each other, each turning end comprising a series of three right-angle bends in the same direction. The manner of bending in the electric heating component 301 may change the direction of adjacent sections of the electric heating component 301 so that each adjacent section passes between adjacent sections of the filter medium 201. At the same time, when interleaved, the bends in the turning ends of the electric heating component 301 are perpendicular to the bends in the filter medium 201. As shown in FIGS. 13-16, the electric heating component 301 can have a corrugated structure, and it can pass between adjacent sections of the filter medium 201, change direction by bending at a turning end, pass between adjacent sections of the filter medium 201 containing the next section of the filter medium 201, and so on. The electric heating component 301 can pass through most or substantially all of the adjacent sections of the filter medium 201 in turn, and it may intersect with the filter medium 201 in horizontal and vertical directions, as shown in FIGS. 13-16. In this way, the electric heating component 301 can have a corrugated structure or a series of right-angle bends, and the number of bends in the electric heating component 301 can be determined according to design considerations or the actual demand.

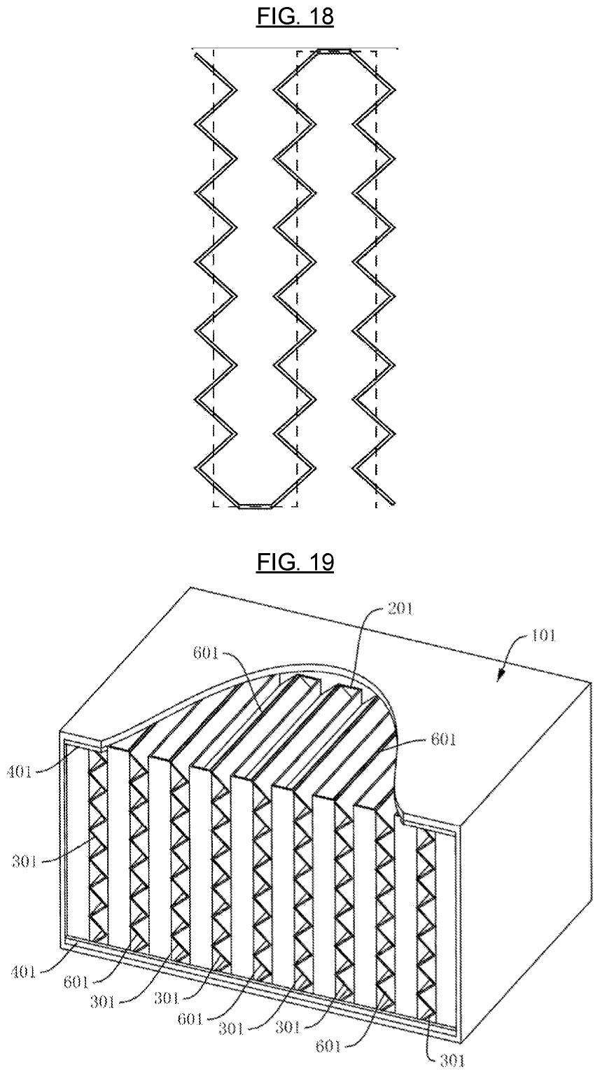

In this interlocking or interleaving way, the electric heating component 301 and the filter medium 201 can not only solve the problem of low heat transfer efficiency, but also improve the heat transfer efficiency by increasing the contact area between the electric heating component 301 and the filter medium 201, and solve the inconvenient installation and positioning of the electric heating component 301 during installation. In particular, the problem(s) associated with accurate vertical installation and positioning of a single sheet-shaped electric heating component can be solved, the installation process may be simplified, and the installation efficiency and the installation precision may be improved. As an example, when the electric heating component 301 includes one turning end (which may include two, three or four bends), a U-shaped or V-shaped electric heating component 301 can be formed, as shown in FIG. 17. When the electric heating component 301 includes two or more turning ends as shown in FIG. 18, the electric heating component 301 (which may have a corrugated structure or a series of alternating right-angle bends or alternating pairs of right-angle bends, and which may have an S-shaped or N-shaped structure), it can be conveniently placed and/or inserted into the multiple bends 202 of the filter material 201, and the functions of supporting and separating the filter material 201 can also be achieved.

Similarly, in order to effectively control the spacing of the filter medium 201 on both sides of the bend 202, the electric heating components 301 can have a wavy structure, a corrugated structure, or a series of right-angle bends along its length (as shown in FIGS. 9, 10, 13, 17 and 18), so as to effectively change and/or control the thickness of the electric heating components 301 and/or the spacing between adjacent sections of the filter medium 201, and thus effectively solve the problem of controlling spacing at the bends 202 and/or between adjacent sections of the filter medium 201.

### Example 3

The main difference between embodiment 3 and the above embodiments 1 and 2 is that the air filter in embodiment 3 also includes a number of baffles 601 in the filter channel 102. The baffles 601 may also be in or adjacent to one or more selected bends 202. The baffles 601 may support and separate the filter medium 201 on opposite sides of the bend(s) 202. That is, the baffle 601 can be installed in the absence or in place of one or more electric heating components 301.

In the filter medium 201, the baffle(s) 601 can be placed or inserted to support and separate adjacent sections of the filter medium 201 on opposite sides of the bend 202. In other words, apart from the electric heating components 301, the baffle 601 may also be placed in the filter 201, as shown in FIG. 19. The electric heating component 301 and baffle 601 may be respectively placed in different spaces between sections of the filter medium 201. When the electric heating component 301 and baffle 601 are not heated, they both support the filter medium 201 and separate sections of the filter medium 201. When the electric heating component 301 is energized, it can also heat the filter medium 201 and/or the air passing through the filter.

According to the function of the baffle 601, in this embodiment, it is not necessary to use the baffle 601 for heating. Therefore, it is not necessary to consider the conductivity of the material(s) of the baffle 601, and such material(s) may be chosen on the bases of cost, stiffness and strength. For example, baffle 601 can preferentially comprise an aluminum, plastic or ceramic partition. Further, the structure (e.g., shape, form, dimension[s], etc.) of the baffle 601 can be the same as the structure of the electric heating component 301. For example, the baffle 601 can also have a wavy or corrugated structure along its length, or include a series of right-angle bends, so that the baffle 601 can realize all of the functions of the electric heating component 301 except heating, which effectively solves the corresponding technical problems and achieves the corresponding technical effect.

In this example, the number and location of electric heating components 301 and baffles 601 can be set according to design considerations and/or criteria or actual requirements to perform acceptably in different situations.

### Example 4

An electric heating component 301 having various structures is in Embodiments 1 and 2, and a baffle 601 is provided in Embodiment 3. The air filter provided in Embodiment 4 may include several baffles 601 and one or more of the electrical heating components 301. The number of electric heating components 301 can be determined according to design considerations and/or criteria or actual demand, and the electric heating component(s) 301 can be preferentially placed in spaces between certain adjacent sections of the filter medium 201, and the baffles 601 placed in spaces between other adjacent sections of the filter medium 201.

According to various considerations, the composition of the air filter may also vary. For example, an air filter may include the filter medium 201 with twenty (20) bends 202, four (4) electric heating components 301 with a sheet structure as described in Embodiment 1, and one electric heating component 301 with a series of right-angle bends as described in Embodiment 2. In addition, the number of right-angle bends in the electric heating component 301 can be five (5). Among the 20 bends 202 of the filter medium 201, 10 of the bends 202 may be located on the windward side 203 of the filter medium 201, and the other 10 bends 202 may be located on the leeward side 204 of the filter medium 201. During installation, the electric heating component 301 having right-angle bends can be placed between sections of the filter medium 201 in a middle position of the filter medium 201, toward the leeward side 204 of the filter medium 201. Two of the electric heating components 301 with the sheet structure can be placed respectively near the ends of the filter medium 201, towards the windward surface 203, and a baffle 601 can be placed in a remaining space between sections of the filter medium 201 not containing a section of an electric heating component 301. In actual use, the electric heating component 301 having right-angle bends can be connected to the power supply through one or more connectors 501 to realize heating independently. The electric heating component(s) 301 having a sheet structure can also be connected to the power supply through one or more separate connectors 501 to realize heating independently. The electric heating component 301 having right-angle bends and the electric heating components 301 having the sheet structure can also be connected to the power supply at the same time for simultaneous heating, so that it can effectively control the heating area, the heating rate, and temperature uniformity.

### CONCLUSION/SUMMARY

The above embodiments are descriptions of specific implementations of the invention, but the scope of protection of the invention is not limited thereto, and it is within the level of skill of a technical person familiar with the technical field to think of changes or replacements within the scope of the technology disclosed by the invention, which shall be covered by the scope of protection of the invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An air filter, comprising:
a) a filter channel;
b) an outer frame enclosing the filter channel;
c) a filter medium that is transverse to and/or that crosses the filter channel; and
d) one or more electric heating components in the filter channel configured to heat the filter medium and/or air in the filter channel.

2. The air filter of claim 1, wherein the one or more electric heating components comprise a metal or a conductive metal alloy.

3. The air filter of claim 2, wherein the one or more electric heating components comprise stainless steel, nickel, a ferrochromium-aluminum alloy or a nickel-chromium alloy.

4. The air filter of claim 2, wherein the filter medium comprises a glass fiber filter sheet.

5. The air filter of claim 1, wherein the filter medium has at least one bend along a transverse direction of the filter channel.

6. The air filter of claim 5, wherein the one or more electric heating components is between adjacent sections of the filter medium on opposite sides of the at least one bend, and the one or more electric heating components is configured to support the filter medium and separate the adjacent sections of the filter medium.

7. The air filter of claim 5, wherein the one or more electric heating components comprises a plurality of parallel sections joined by one or more bends, the one or more electric heating components is interleaved with the filter medium, and the one or more bends in the one or more electric heating components is perpendicular to the at least one bend in the filter medium.

8. The air filter of claim 1, wherein the filter medium has a wavy or corrugated structure or comprises a series of alternating pairs of right-angle bends.

9. The air filter of claim 1, wherein the one or more electric heating components comprises a sheet, a corrugated structure or a series of alternating right-angle bends.

10. The air filter of claim 1, wherein the one or more electric heating components comprises a mesh or a plurality of holes.

11. The air filter of claim 1, wherein the one or more electric heating components comprises a metal net comprising woven metal wires.

12. The air filter of claim 1, wherein the one or more electric heating components comprise a wave-shaped or corrugated structure or a series of alternating right-angle bends along its length.

13. The air filter of claim 1, wherein each of the one or more electric heating components are connected to a power supply connector, or when the one or more electric heating components comprises a plurality of the electric heating components, at least two of the plurality of the electric heating components are connected to power supply connectors.

14. The air filter of claim 13, wherein adjacent ones of the plurality of the electric heating components are connected in series with a conductive sheet or wire, and at least one electric heating component is between two of the power supply connectors.

15. The air filter of claim 13, further comprising a sealant or adhesive on the outer frame, fixing opposite ends of the filter medium and the one or more electric heating components to the outer frame.

16. The air filter of claim 15, wherein at least part of each power supply connector is in the sealant or adhesive.

17. The air filter of claim 5, further comprising one or more baffles in the filter channel.

18. The air filter of claim 17, wherein each of the one or more baffles is between adjacent sections of the filter medium on opposite sides of the at least one bend, and is configured to support the filter medium and separate the adjacent sections of the filter medium.
